(19) United States
(12) Patent Application Publication
(10) Pub. No.: US 2013/0180165 A1
(43) Pub. Date: Jul. 18, 2013

(54) MOBILE PRODUCTION OF BIODIESEL WITH ULTRASOUND

(71) Applicant: Alex Noqueira Brasil, Itauna - MG (BR)

(72) Inventor: Alex Noqueira Brasil, Itauna - MG (BR)

(73) Assignee: BIOMINAS ENGENHARIA E INDUTRIA DE ENERGIA LTDA., Itauna - MG (BR)

(21) Appl. No.: 13/727,119

(22) Filed: Dec. 26, 2012

(30) Foreign Application Priority Data
Dec. 26, 2011 (BR) PI1105959-1

(51) Int. Cl. B01J 19/10

(52) U.S. Cl. CPC B01J 19/10
USPC 44/639

(57) ABSTRACT

A portable production system for biodiesel production is contained within a rolling chassis. A reactor connected to the rolling chassis includes a transparent reaction vessel which houses ultrasonic transducers arranged to disperse ultrasonic energy to a biodiesel precursor, to promote a transesterification reaction of vegetable oil and or animal fat. A mechanical stirrer, also disposed within the reaction vessel, stirs the reactants. A heater, likewise disposed within the reaction vessel, has at least one cover shaped to change a flow of reactants within the reactor vessel as they are stirred by the stirrer.

### CROSS-REFERENCE TO RELATED APPLICATIONS

This application claims benefit of Brazilian Patent Application PI1105959-1 A2, filed Dec. 26, 2011, and published Jun. 19, 2012 as Brazilian Patent Publication 14110003584, the contents of both of which are hereby incorporated by reference in their entirety.

### FIELD OF THE INVENTION

The present invention relates to biodiesel production, and more particularly to biodiesel production in a mobile production facility using ultrasound.

### BACKGROUND OF INVENTION

Industrial production of biodiesel is typically based on transesterification of vegetable oils and animal fat using methanol or ethanol as the esterifying agent, and using homogeneous catalysts, especially strongly alkaline ones, such as sodium or potassium hydroxide methoxide, and sodium methoxide. Other methods, conducted in batch or semicontinuous processes, include the use of microwave energy.

For example, U.S. Patent Application 2004/0074760 A1 describes a “reactional” route in which a catalyst is mixed with the oil, and microwave energy is applied to force the mixture after the addition of a source of alcohol. It has been stated that this system is capable of producing not only biodiesel, but also fractional distillation products, such as gasoline and kerosene.

Brazilian patents PI 0603386-5 A, PI 0703023-1 A2 and UM 8602286-5 U disclose high production capacity plants, starting from 1,000 liters/day, and costing in excess of

R$500,000.00 (five hundred thousand reais).

In Brazilian patent application PI 0404243-3, a process is disclosed for the production of biodiesel from semi-refined vegetable oil, using anhydrous alcohol and an alkaline catalyst in a heated reaction environment occurring in two stages. Both occur at temperatures between 60-80° C. when, after the first step, the products are sent to a heating stage for retrieval of the unreacted alcohol by evaporation, followed by its condensation. Once the liquid mixture is cooled and separated into two phases, the lighter one, a mixture of esters and oil, and the more dense one, being a phase which is rich in glycerin. The light phase is directed to a second reactor, where more alcohol is added in accordance with the need for continuity of the reaction, in order to achieve the desired transformation. The catalyst is neutralized with an acid additive; the alcohol, eventually in excess, is retrieved, and the phases, products of the reaction, are separated by decantation or centrifugation. The phase of interest, the light one, is washed with a water mixture, and thereafter, is strongly heated to remove the water incorporated in the organic phase.

In Brazil patent PI 0503631-3, a process is disclosed for the production of biodiesel, and particularly castor oil, but is also applicable to other sources of oil, whose catalytic process, acid or base, occurs in two stages, the first one in two reaction vessels in parallel. The phases are separated into a first light phase and a second, more dense phase. The first phase is directed to a second reactor, where the lines of the first two tanks mix, for a second reaction step. This process also highlights the reuse of some of the catalyst available in the glycerin, it is the most dense part aforementioned, to reduce the emission of waste. Another aspect to be noted regards the retrieval of the alcohol, which must be added in excess to the reaction, so that it takes place more quickly and efficiently. This retrieval step is performed after the separation of phases, and the washing of the fuel produced, as a purification step.

Brazilian patent number PI 0700307-2 A discloses a biosonic system for production of biodiesel through pumps, more specifically, through the use of cavitation pumps.

In Brazilian patent number PI 0604251-1 A, vegetable oils, when extracted, either for use of organic solvents or in pressing process, contain in their composition not only the triacylglycerides, but also some organic acidity to some extent, due to the presence of free fatty acids.

Stavarache Carmen et al. discloses, in “Fatty acids methyl esters from vegetable oil by means of ultrasonic energy”, Ultrasonics Sonochemistry 12 (2005) 367-372, tests of alkaline transesterification of vegetable oils through the use of laboratory baths of low frequency ultrasound at 28 and 40 kHz.

### SUMMARY OF THE INVENTION

In accordance with the disclosure, a portable production system for biodiesel production, comprises a reactor including—a reaction vessel; one or more ultrasonic transducers disposed within the reaction vessel configured to subject a biodiesel precursor to ultrasonic radiation to promote a transesterification reaction of vegetable oil and or animal fat; a heater; and a mechanical stirrer.

In an embodiment thereof, the system is supported by a chassis having a plurality of casters, and fittings for lifting of the chassis. In a further embodiment, the system further includes one or more pumps for changing air pressure; one or more pumps for liquid; a tank for holding a recovered reactant; a tank for holding biodiesel produced.

In other embodiments, the system further includes a dry wash purification column; the one or more ultrasonic transducers are piezoelectric transducers; the one or more ultrasonic transducers are submerged within the reaction vessel; the one or more ultrasonic transducers are contained within a housing; the housing is fabricated with titanium; the one or more ultrasonic transducers include a plurality of ultrasonic transducers arranged at an angle with respect to each other, to disperse ultrasonic energy throughout the reaction vessel; and the reaction vessel is transparent.

In yet further embodiments, the heater includes one or more heater elements having a heater cover shaped to change a flow of reactants stirred by the mechanical stirrer; the mechanical stirrer includes an assembly having a motor, an output shaft connected to the motor, and one or more propellers connected to the output shaft.

In various embodiments, a plurality of the mechanical stirrer includes a plurality of the assembly; decantation and distillation, in addition to the ultrasonic radiation and stirring, are carried out in the reaction vessel; and the one or more ultrasonic transducers include a plurality of ultrasonic transducers arranged within a columnar housing, each ultrasonic transducer disposed at an angle with respect to another ultrasonic transducer, the plurality of ultrasonic transducers thereby being protected by the columnar housing and disposed to disperse ultrasonic energy throughout the reaction vessel.

In other embodiments, the columnar housing is fabricated to promote the propagation of ultrasonic energy into the reaction vessel; the columnar housing is fabricated with titanium; and the at least one ultrasonic transducer operates at one or more frequencies between about 19 kHz to 40 kHz.

In another embodiment of the disclosure, a portable production system for biodiesel production, comprises a rolling chassis; a reactor connected to the rolling chassis, and including—a reaction vessel; one or more ultrasonic transducers disposed within the reaction vessel configured to subject a biodiesel precursor to ultrasonic radiation to promote a transesterification reaction of vegetable oil and or animal fat; a mechanical stirrer disposed within the reaction vessel; and a heater disposed within the reaction vessel and having at least one cover shaped to change a flow of reactants within the reactor that are stirred by the stirrer.

In a further embodiment of the disclosure, a portable production system for biodiesel production, comprises a chassis; a reactor connected to the rolling chassis, and including—a reaction vessel; one or more ultrasonic transducers configured to transmit ultrasonic radiation into an interior of the reaction vessel; a mechanical stirrer disposed within the reaction vessel; and a heater disposed within the reaction vessel and having at least one cover shaped to change a flow of reactants within the reactor that are stirred by the stirrer.

### BRIEF DESCRIPTION OF THE DRAWINGS

The accompanying figures, where like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 depicts a process flow for the production of biodiesel in accordance with the disclosure;

FIG. 2 depicts a front perspective view of a mobile production plant or facility of the disclosure, operative to carry out the procedure of FIG. 1;

FIG. 3 depicts a rear perspective view of the facility of FIG. 2, with one or more panels removed to reveal interior components;

FIG. 4 depicts a detailed view of the reaction chamber or vessel of the facility of FIG. 2, including a mixer and heater elements;

FIG. 5 depicts an enlarged view of the ultrasonic reaction vessel of the facility of FIG. 1, visible in FIG. 2;

FIG. 6 depicts an exploded view of the ultrasonic reaction vessel of FIG. 5;

FIG. 7 depicts an ultrasonic energy power generator of the facility of FIG. 1;

FIG. 8 depicts an alternative ultrasonic reaction vessel in accordance with the disclosure, including a submerged or immersed ultrasonic radiation column;

FIG. 9 depicts an alternative multifunction reactor in accordance with the disclosure, including heating and mixing components, and an ultrasonic column; and

FIG. 10 depicts a computer system which may be used with a facility of the disclosure.

### DETAILED DESCRIPTION OF THE INVENTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The terms “a” or “an”, as used herein, are defined as one or more than one. The term plurality, as used herein, is defined as two or more than two. The term another, as used herein, is defined as at least a second or more. The terms “including” and “having,” as used herein, are defined as comprising (i.e., open language). The term “coupled,” as used herein, is defined as “connected,” although not necessarily directly, and not necessarily mechanically.

In accordance with the disclosure, it has been determined that it is advantageous to avoid excessive inputs which are external to the production route. Further, the use of a catalyst in a two stage reaction can interfere with reaction kinetics, where the reaction product is reprocessed as an input. Further in accordance with the disclosure, some “non-saponifiable matter, for example certain compounds that are not transformed into biodiesel when transesterification reaction occurs, as well as gums, can be kept in the oil, even if they are not transformed, for they provide some advantageous characteristics to the oil and fuel, such as stability to oxidation, as in the case of tocopherols and sterols. Further, the use of an ultrasonic bath results in good results in terms of conversion into ester, as well as improved reaction time, on an industrial scale.

More particularly, improvements in transesterification processes, in accordance with the disclosure, use ultrasound to increase a degree of conversion, and to reduce reaction time and power consumption. A production unit of the disclosure tends to be more compact than other processes, especially where continuous production processes are conducted, which favor the construction of small-scale production at a low cost.

The disclosure additionally provides alternative catalysts, particularly for processes in heterogeneous catalysis. This reaction environment can be advantageouss over the homogeneous process, for example being easier to use in a continuous process; providing a possibility to obtain a cleaner glycerin; and the absence of a step of neutralization of the catalyst and the continuous addition of this material during the process.

The disclosure provides equipment for the production of biodiesel, and provides a reaction and processing system that improves conditions and characteristics of industrial processes of biodiesel production using ultrasound irradiation. The equipment enables the study, knowledge and control of important process variables. The equipment has the form of a facility, plant or production unit, and can be fixed or mobile, and can be used to produce relatively small amounts compared to known continuous process methods, enabling a saving in the use and consumption of reagents and supplies, as well as having the characteristic of being portable, that is, easily transported and deployed in small spaces.

The device and methods of the disclosure contribute to the sustainable development of biodiesel production using novel heterogeneous catalysts; ultrasound irradiation to foster greater interaction between the phases and a consequent increase in yield; and by enabling reduced reaction time and reagent consumption to save energy. Ultrasonic energy is used for industrial production while flexibly supporting variations in process parameters, including amounts of vegetable oil, alcohol, and catalyst, and variations in time, temperature, distillation, and decantation. The reactor of the disclosure enables the synthesis of biodiesel through irradiation with ultrasound, and includes reservoirs in transparent borosilicate-type glass, which enable visual monitoring of all process steps. The reactor is additionally constructed using stainless steel in other aspects, as well as polymeric material resistant to biodiesel, for seals in particular.

The disclosure enables a small amount to be processed, for example six liters per batch, although smaller quantities are possible. Additionally, the system of the disclosure is scalable, so that it can be sized to produce smaller batches, for example for teaching, or much larger batches, for example to provide fuel for a large fleet of vehicles. The system of the disclosure provides savings in the use and consumption of reagents and supplies, and can be easily transported and deployed in small spaces. A continuous process in low volumes is also supported. The reactor/system uses a dry purification process, or “drywash”, by means of ion exchange polymer resin, without generating waste wash water, which can otherwise be problematic in conventional biodiesel production.

The system of the disclosure includes a self-contained production plant for the production of biodiesel using irradiation with ultrasound, including the generation of conditions and characteristics of a large scale industrial production process, in a mobile production facility. However, the equipment is relatively low cost, and is easy to relatively easier to use. In addition, the system is transportable, for example upon a truck, or within a marine shipping container. It is capable of producing up to six liters of biodiesel per batch or performing the reaction by ultrasound continuously. Its small dimensions is particularly advantageous, for example, in a classroom, or for use by laboratories needing to produce and analyze biofuels. Larger industrial quantities, for example for use in transportation or shipping vehicles or vessels, may also be produced in accordance with the disclosure.

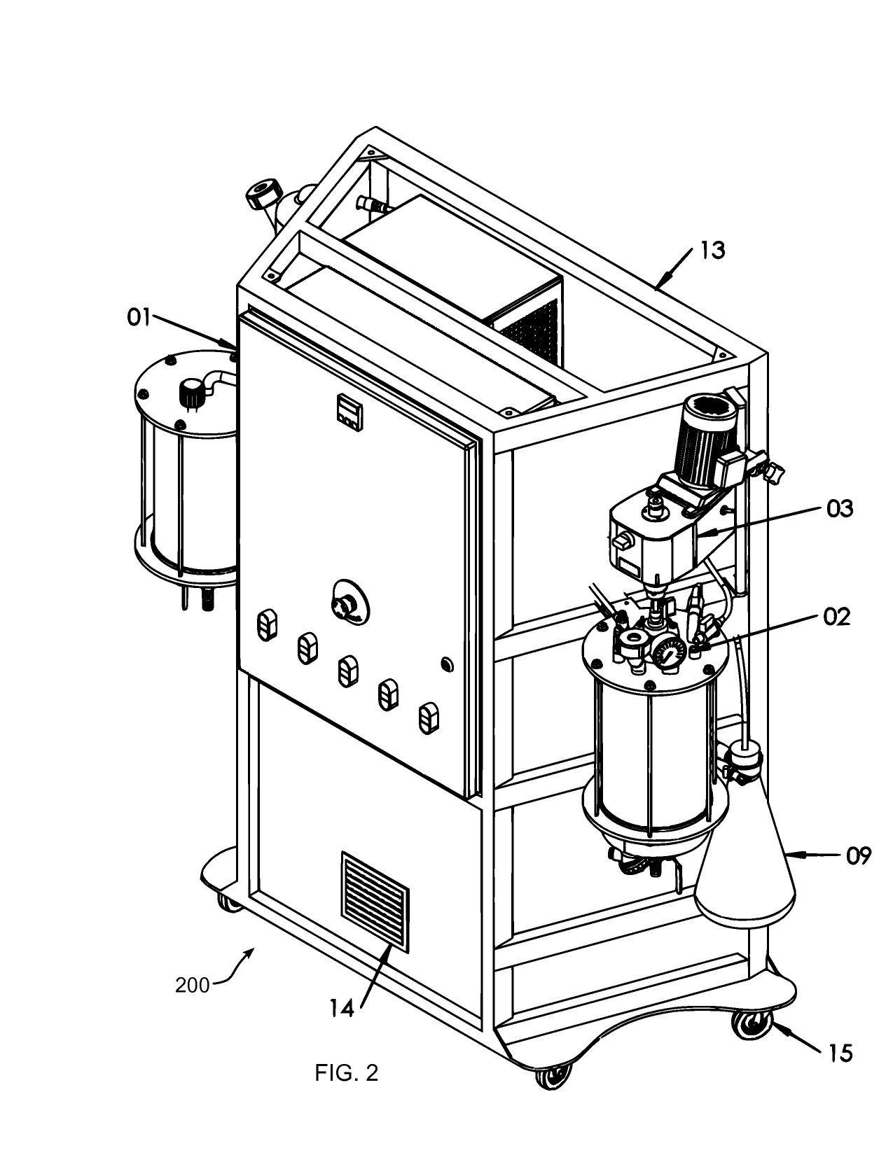

The production system illustrated in FIGS. 2-8 works with any type of oilseed oils, including those coming from processes of cooking foods. Ethyl and methyl alcohols can be used as reagents in the process. Ethanol has advantages of being derived from renewable sources, and can have greater availability. Sodium methylate (30%) can be used as a catalyst, although other homogeneous and heterogeneous catalysts may also be used.

Materials used in pipes, fittings, stop valves, and tanks are selected for adequate durability, resistance to corrosion and undesired reaction, and cost. Similarly, the manufacturing process of the tanks and construction of the ultrasound reactor correspond to the joining, coupling, and care of the materials used.

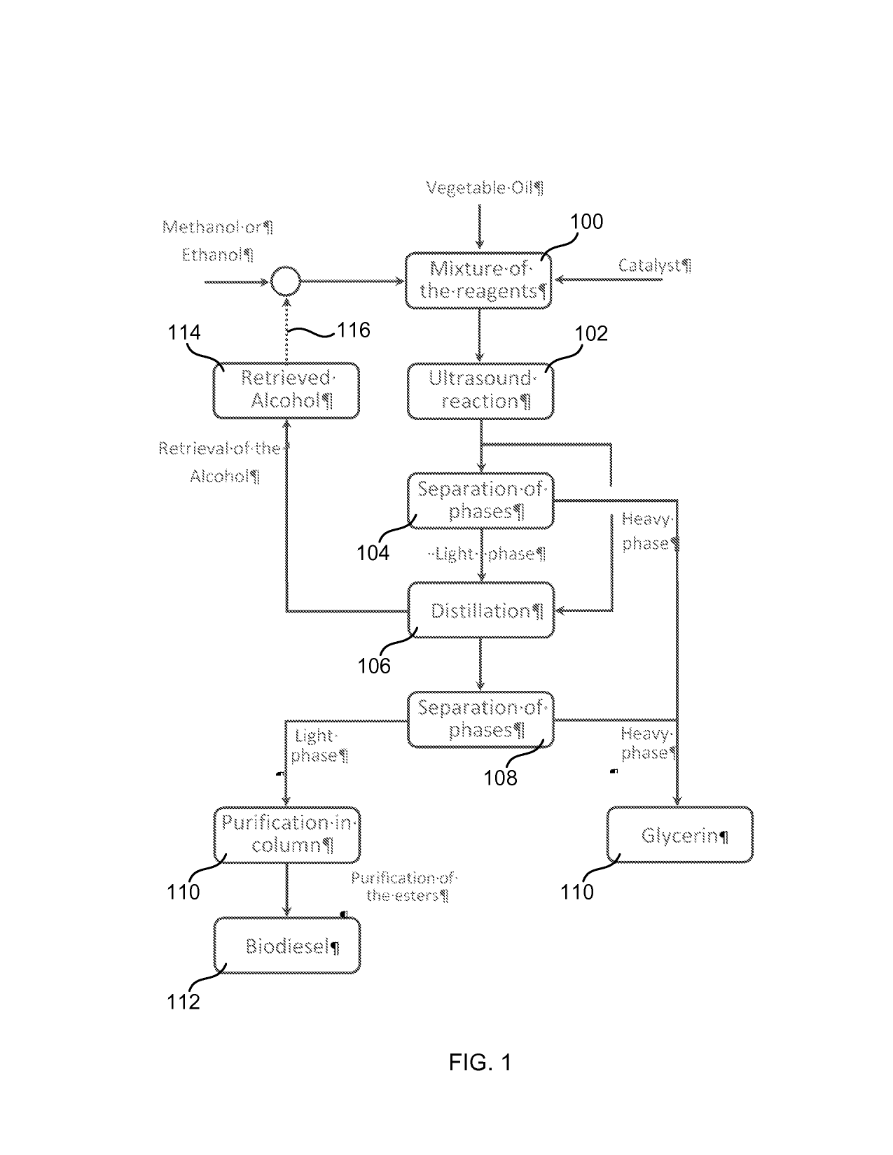

FIG. 1 illustrates an exemplary process flowchart of the disclosure, identifying various process stages, as follows. A mixture of the reagents 100 is conducted, in which the reagents of the process, including alcohol, oil and catalyst, are mixed by mechanical stirring under controlled temperature. A transesterification reaction 102, which produces biodiesel and other products, is performed by irradiation with ultrasound. The retrieval of excess alcohol 104, for example ethyl or methyl alcohol used in the reaction phase 102, is conducted by distillation. This alcohol may be retrieved 114 and reused 116; for example, it may be reintroduced in subsequent batches or continuous process streams. A separation of ester and glycerin phases 104 is carried out by gravity, before and/or after the distillation step 106. To reduce time and or to improve yield or purity, a centrifuge may be used (not shown). The process produces a heavy phase which includes glycerin 110 and a light phase which includes biodiesel, 112, which can be further purified in a column 110. More particularly, the heavy glycerin phase cab be directed by gravity to its target reservoir, and the light phase, fatty esters, is purified in one or more columns, for example. The resultant biodiesel is stored in a target tank.

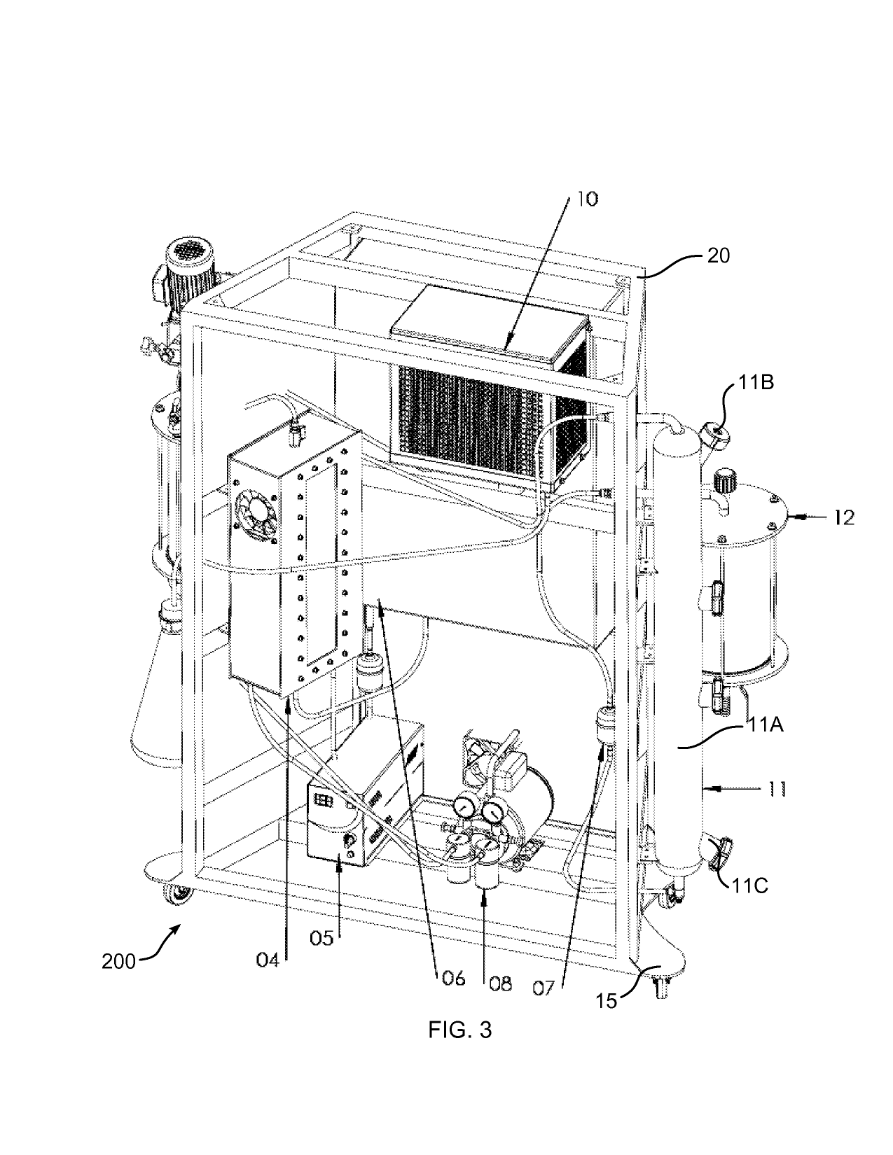

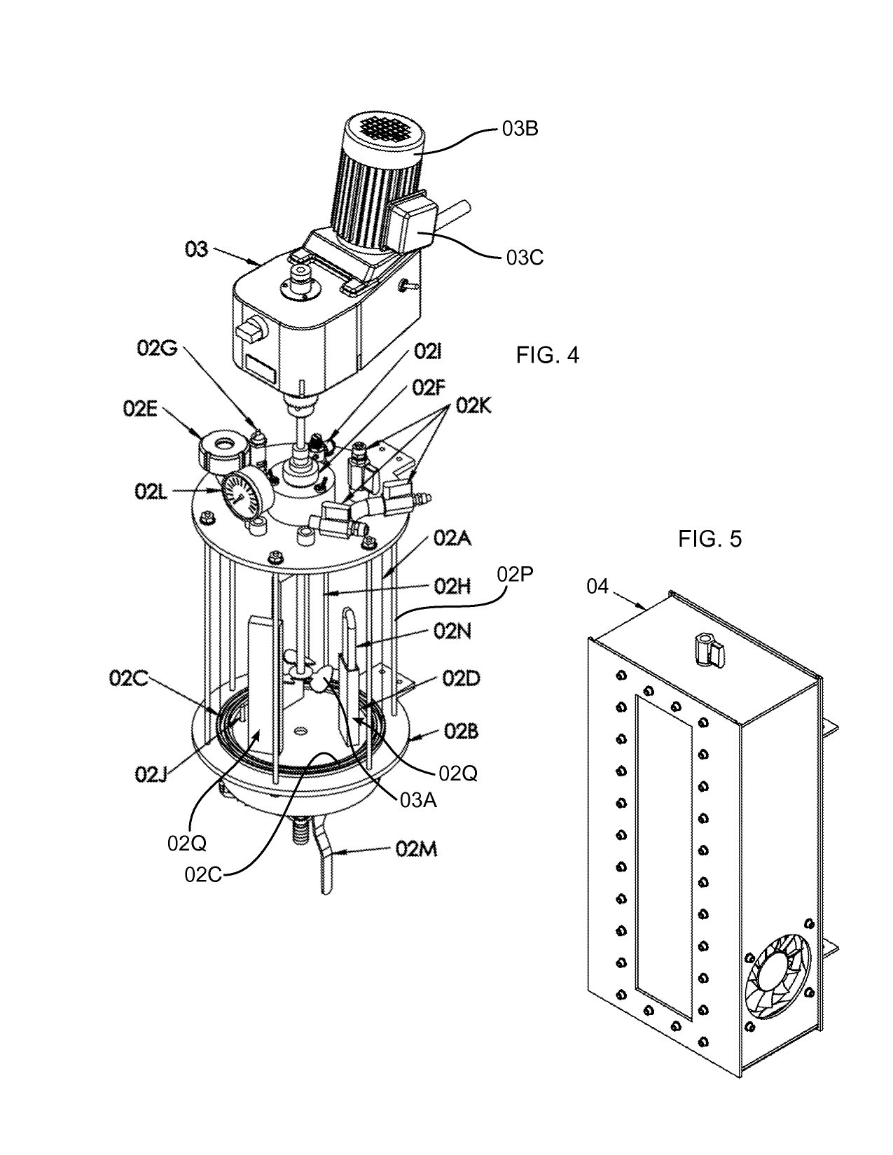

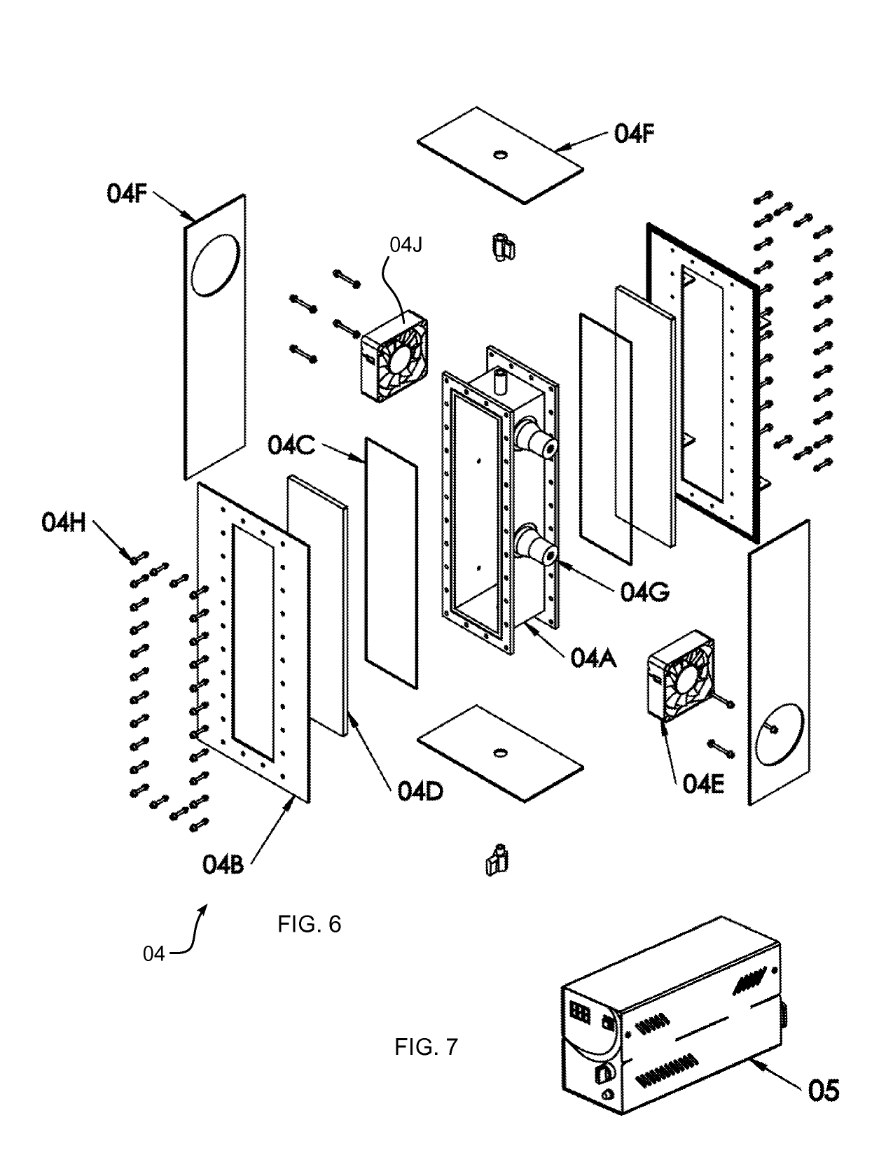

An exemplary system 200 of the disclosure is shown in FIGS. 2-8. A front and back view of system 200, which is an apparatus for carrying out the steps detailed in FIG. 1 is illustrated in FIGS. 2 and 3, respectively. FIG. 4 illustrates components of system 200, including a primary mixing reactor 02, and FIG. 5 illustrates additional components of system 200, including a secondary ultrasonic reactor 04, as shown mounted to a frame 13, in FIGS. 2-3. FIG. 6 depicts an exploded view of secondary ultrasonic reactor 04 of FIG. 5.

Structural mobile chassis 13, comprises a rigid supporting frame for positioning and securing one or more components of system 200 relative to each other. Chassis 13 can be equipped with pad eyes (not shown) to facilitate lifting, as well as skids, wheels, or casters 15 to facilitate movement or rolling of the assembly 200. Where system 200 is incorporated into a movable vehicle, for example a motor vehicle or vessel, or a trailer, chassis 13 may be fastened to the vehicle, or the vehicle may incorporate chassis 13.

An electrical panel, or central control 01, can control operation of one or more elements of system 200, including pump 06, mechanical stirring equipment 03, an equipment and system of compressed air and vacuum flow 08, distiller 02, and ultrasonic reactor 04, to be switched on and off, and to control heating of the first multifunctional reactor. It can include a digital temperature controller, which permits monitoring of the process temperatures. For security, it can include an emergency button. Any or all aspects of control 01 may be performed by one or more of a computer system 1000.

With reference to FIG. 4, transparent container/bin 02A of first multifunctional reactor 02, which can be transparent, is heatable by an internal electrical heating element assembly 02Q, having electrical elements 02N that are encapsulated by a cover 02D which encloses, encases, or otherwise isolates contents placed into bin 02A from elements 02N. One heating element assembly 02Q is shown in cut-away form in FIG. 4. Control 01 can be used to control a temperature or on-time of resistor 02N and thereby the temperature of contents placed into bin 02A, for example at a temperature between room temperature and 120° C. Mechanical stirrer 03 includes a propeller 03A, for example a naval or marine propeller, which is rotated by a motor, for example electric motor 03B, having a speed regulated by a motor controller 03C, and or by control 01.

Bin 02A can be fabricated with a material that is highly resistant to thermal stress, for example a borosilicate-type glass, in the form of a cylindrical body. Stainless steel flanges or supports 02P, and polymeric seals 02C, resistant to the process reagents, may further be used to strengthen and complete bin 02A. In addition to promoting the execution of the transesterification reaction, including providing containment, mixing, and heat, reactor 02 has a second function as a decanter for separation by gravity of the ester and glycerin phases, and a third function as a distiller for removal of excess alcohol from the reaction stage.

As discussed, internal covers 02D, fabricated for example of stainless steel, cover internal electrical resistance heating elements 02N, which provide heat for heating of the process reagents. Covers 02D additionally facilitate the mixture of materials, reducing or preventing the formation of a vortex during the agitation of the mixture, by interrupting the generation of the vortex pattern.

Reactor 02A can further include injection of compressed air, and can have flow control valves for adjusting the rate of injection. Additionally, inlets are provided for feeding of an input mixture on the upper side and four outputs, two upper and two lower ones, which can be controlled by a manual valve of tripartite sphere, and a flow control valve.

An inferior, or lower output is provided for allocation of the reaction mixture to a subsequent reaction step by ultrasound, if ultrasound is not carried out in reactor 02 itself, and another output can be provided for removal of the heavy phase (glycerin). An upper output can be provided for forwarding processed biodiesel to a subsequent purification stage, if complete or final stage purification is not performed in reactor 02, and another outlet for removing and retrieving alcohol for recycling or reuse. Coupled to this output, a vacuum pump can be provided for facilitating removal and separation of the alcohol vapor from the evaporation atmosphere.

Mechanical stirrer 03 includes a pole or output shaft 03P connected to naval propeller 03A, advantageously fabricated from stainless steel. Stirrer 03 can include variable rotation speeds from 5 to 5000 rpm, thereby being configured for stirring substances with a range of viscosities, and enabling the production of a homogeneous mixture. Stirrer 03 can advantageously provide constant or continuous stirring.

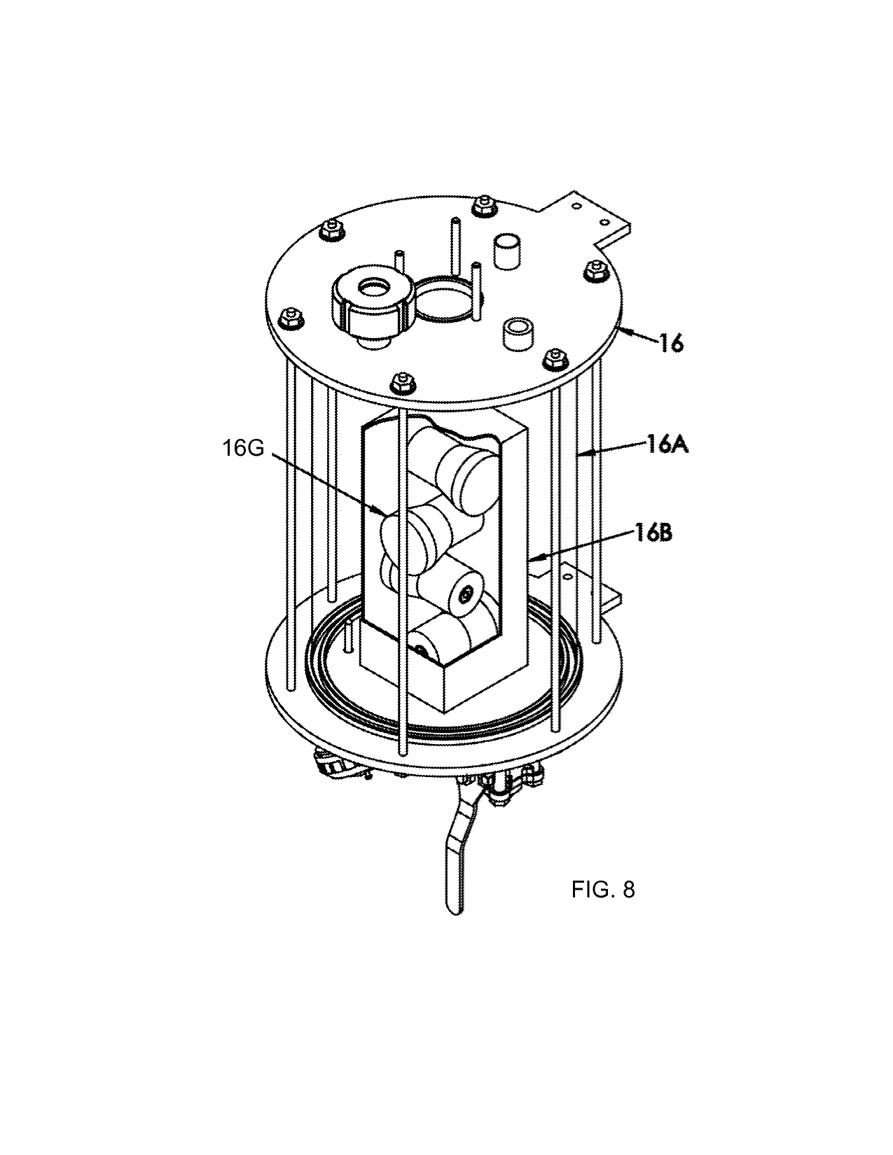

In addition to, or as an alternative to ultrasonic irradiation conducted within reactor 02, a second reactor 04 can be connected to pretreated product from reactor 02, to provide for initial or subsequent irradiation by ultrasound, controlled by an ultrasonic generator 05 (FIG. 7), which can include a reaction parameter control system, which can be electronic, and can include a computer. Advantageously fabricated with stainless steel, second reactor 04 has ultrasonic transducers which can be constructed with transducers including piezoelectric crystals 04G, which advantageously produce a frequency between about 19 kHz and about 40 kHz. In one embodiment, frequency is advantageously between about 19 kHz to about 28 kHz. In another embodiment, the frequency is about 19 kHz. It should be understood that other frequencies can be used to promote transesterification, including frequencies as low as 10 kHz, and as high as 60 kHz, for example.

With reference to FIG. 6, a reactor column 04A is cooled with a transducer cooling system 04E, such as a fan 04J, or alternatively a radiator, not shown. Transparent displays 04D can contain the reactants, and enable visualization of the reaction within second reactor 04.

With reference to FIG. 8, an alternative or supplement to the second reactor 04 is ultrasonic reactor 16, which includes a submerged reactor column 16B, containing one or more submergible ultrasonic transducers 16G (shown in a cutaway view of column 16B), which can be piezoelectric ultrasonic transducers. In one embodiment, a plurality of ultrasonic transducers 16G are oriented dispersed throughout the bin or vessel 16A, which can be transparent, and which contains the reactants to be treated by ultrasound. Without being bound to a particular theory, ultrasonic energy can disperse the reactants together, reducing particle size, and improving contact between the reactants, thereby increasing the speed and efficiency of the reaction. In one embodiment, transducers 16G are housed within a column 16B, and column 16B is itself submergible within the reactant. In an embodiment, column 16B is fabricated from a material that optimally transfers ultrasonic energy into vessel 16A.

Column 16B can be fabricated, for example, using titanium or another metal or material, for example, of a thickness optimized to resonate or transmit the desired frequency or frequency range produced by transducers 16G. In an embodiment, each transducer 16G is oriented to project ultrasonic energy into a different zone or region of column 16B, for example transducers 16G are oriented vertically within vessel 16A, and for four transducers, oriented at 90 degrees with respect to each other. For additional transducers, the relative angle between them may be smaller, and for few transducers, the relative angle between transducers 16G may be larger, so that transmission complete coverage within vessel 16A is optimized.

Referring again to FIG. 3, one or more fuel pumps 06 can be provided to transfer reactants between vessels, for example to direct the reaction mixture from first reactor 02 to the second reactor 04, during the production process. One or more fuel filters 07 can be provided to retain any particulate being passed, for example from reactor 02, and can be provided upstream of pump 06 to protect pump 06.

One or more vacuum or compressor (negative or positive) air pressure pumps 08 can be provided to promote vacuum in an alcohol storage tank 09, in order to reduce the boiling heat of the alcohol, and thus, to facilitate the distillation process in multifunctional reactor 02. Moreover, air pressure pump 08 can have the function of providing a positive pressure within reactor 02 or other reactor vessel during the biodiesel purification process.

Alcohol tank 09 (FIG. 2), advantageously fabricated with transparent borosilicate-type glass, has an upper side output for coupling air pressure pump 08 and an inlet, for example an upper inlet, for directing the alcohol retrieved during the distillation stage.

With further reference to FIG. 3, heat exchanger 10, advantageously fabricated with, for example, copper pipes and aluminum plates, can be used to remove heat from the alcohol vapor coming from the distillation stage.

One or more “dry wash” purification columns 11 can be provided to remove impurities in the processed biofuel, such as soaps, trace glycerin, and residual catalyst, and can have the form of a tube or cylinder 11A, and is advantageously fabricated with a stainless steel tube.

Purification column 11 can have displays properly positioned to monitor the purification process, and saturation of the resin contained therein. Accesses can be provided in the upper and lower portions, or a side, of cylinder 11A, for supply and removal of ion exchange resin. Upper supply 11B can be provided in the upper part of the tube in polymeric material attached using “quick coupler” connector, and a lower output 11C in the lower part, triggered by a flow controller valve. The flow rate of crude ester in the column is continuous, and the flow is propelled by compressed air supplied by air pressure pump 08. In one embodiment, two dry wash purification columns 11 are provided in a lead/lag configuration, and can each contain a different purification media.

Biodiesel tank 12 can have the form of a cylindrical or other shape body, advantageously constructed with a transparent highly-resistant borosilicate-type glass, with stainless steel support flanges, and seals in polymeric material which is resistant to corrosion from biodiesel. Feeding of the purified biodiesel through the top part, and for dispensing at a lower output, can be controlled by manual valve of tripartite sphere, or can be automated.

Structural mobile chassis 20 can be fabricated with steel, possibly treated or overcoated to protect against corrosion, and provides a support for attachment of the tanks and equipment described herein. For aesthetics, or protection from weather or other contaminants, some or a portion of chassis 20 can be enclosed. To remove heat and production vapors, and to otherwise help cool and protect the components described herein, an exhaust system 14 can be provided, which can include an axial exhaust/suction fan/ventilator. For example, exhaust system 14 can remove any leaked alcohol vapor within or near chassis 20, to protect from environmental exposure or flammable concentrations. Casters 15 can be provided to enable movement and relocation of system 200.

If the reactors 02 and 04, and the tanks 09, 012 are made using borosilicate-type glass, stainless steel support flanges, and polymeric seals, and are connected with stainless steel piping, the total weight of a useful system 200 can, in one embodiment, be approximately 100 kg, and have dimensions of 1250 mm in length×540 mm in width×1400 mm in height. As system 200 can be scaled within a wide range of sizes, system 200 can be lighter and smaller, and much larger and much heavier.

Referring again to FIG. 1, in one embodiment and with more particularity, the process of producing biodiesel occurs as follows. Vegetable oil eventually pretreated is added to first reactor 02 and is heated therein using internal electrical resistance elements 02N. Alcohol, for example methanol, is added and, using mechanical stirrer 03, strong stirring is performed to force a mixture of the two phases. Once the catalyst is added, and under continued mechanical stirring and temperature control, the reaction is carried out. This mixture may remain for as long as it is necessary so that the reaction takes place completely, for example between 60 and 120 minutes. Additionally, the reaction can include the addition of ultrasound, within reactor 02 or in a subsequent reactor (04), until the conversion into ester is achieved, for example to a minimum of 96.5% conversion.

After the reaction of the inputs, biodiesel and glycerin are formed. These will separate before and or after the stage of distillation in the multifunctional reactor 02. Due to the considerable difference in density, the process can be accomplished in part or substantially completely through decantation in the multifunctional reactor 02, with the aid of gravity, saving energy and space, if there is sufficient time to wait for the separation.

In an embodiment, using pump 06, the mixture can reach a higher purity more quickly by being reacted in second reactor 04 using ultrasound, and can be directed back to the first reactor 02 for further processing. For example, when the ultrasonically treated mixture, still containing an excess amount of alcohol, is returned to the first reactor 02, the temperature can be changed using heating element assemblies 02Q, to promote evaporation of the excess alcohol, in order to increase the efficiency and kinetics of the reaction. Vacuum is produced in the system, using pump 08, in order to remove oxygen from first reactor 02, and to reduce the boiling heat of the alcohol, thus avoiding oxidation and subsequent deterioration of the resultant biodiesel. The excess alcohol evaporated in first reactor 02 can be passed through heat exchanger 10, to be condensed and retrieved in alcohol tank 09, for reuse in subsequent processes.

After the distillation stage, the mixture can remain in the first reactor 02 for phase separation by gravity. The heavy fraction, raw glycerin, derived from this phase separation stage, can be removed by gravity with the aid of a stainless steel sphere valve. The light fraction, fatty esters, can be pumped in a continuous flow, passing through purification column 11 with the aid of the air pressure pump 08. The crude biodiesel percolates through ion exchange resin which retains substantially all of the waste of glycerin, catalyst, and salts of the light fraction of fatty esters, obtaining a biodiesel having high purity, for example meeting all applicable ASTM standards, which is directed to biodiesel tank 12.

The distribution of process flow is carried out by flexible polymeric hoses which can be disposed within an interior of chassis 20, and can include the use of stainless steel tubing in visible or exposed areas. The valves can advantageously be of the sphere-type, of stainless steel construction, and tripartite, making it easier to operate and maintain the system, although other types of valves which are sufficiently corrosion resistant, and tight sealing, may be used.

In an exemplary embodiment, fresh vegetable oil is poured into first reactor 02 where it is heated to about 60° C., and is mixed with anhydrous methyl alcohol and sodium methylate 30% in methanol. The mixture is kept under vigorous stirring for 60 minutes until the reaction stage is complete, remaining at rest for another 60 minutes to separate the phases into ester and glycerin. The lower layer containing high concentrations of glycerin is removed by gravity, and the light phase containing high concentrations of fatty esters, remains in first reactor 02 for the next distillation stage, where the excess alcohol will be evaporated with heat, at about 95° C., for 40 minutes, with the aid of vacuum. The evaporated alcohol passes through heat exchanger 10 to condense, and the condensed liquid is then retrieved within alcohol tank 09. The light phase, fatty esters, retained in the first reactor 02, is driven in a continuous flow of 8 liters per hour, with the aid of vacuum and air pump 08, to the purification column 11, through which the crude biodiesel can percolate through an exchange resin, for example a polymeric ion exchange resin, which retains substantially all of the residues of glycerin, salts and catalyst. Still advantageously in continuous flow, the purified biodiesel is stored in tank 12.

In another example of the disclosure, received waste vegetable oil is poured into first reactor 02 where it is heated to 55° C. and is mixed with anhydrous methyl alcohol and sodium methylate 30% in methanol. The mixture remains under strong stirring for about a minute, and is then directed by pump 06 to second reactor 04, at flow rate of 110 liters per hour, recirculating between the first and second reactors for 15 minutes, until the contents of ester of at least 96.5% is reached. Returning to the first reactor 02, the excess alcohol will be evaporated by heating at 95° C., for 40 minutes, with the aid of vacuum. The evaporated alcohol passes through heat exchanger 10 to condense, and is then retrieved in alcohol tank 09. The production phases retained in first reactor 02 remain sitting for about 60 minutes, to allow the separation of the phases into glycerin and ester, which occurs by gravity. The heavy phase, raw glycerin, is then removed through a bottom valve, and the light phase, fatty esters, is directed, advantageously under a continuous flow of about 8 liters per hour, with the aid of vacuum and compressed air pressure pump 08, to the purification column 11, where the crude biodiesel percolates through the polymeric ion exchange resin, which retains a required amount of residues of glycerin, salts and catalyst. Still in continuous flow, the purified biodiesel can be stored in its reservoir/tank 12, or can be dispensed.

In another embodiment, in natura vegetable oil is poured into first reactor 02, where it is heated to 65° C. and mixed with anhydrous ethyl alcohol and sodium methylate 30% in methanol. The mixture remains under strong stirring for a minute, and is then directed by pump 06 to second reactor 04, at a continuous flow of one liter per minute, returning to first reactor 02. The excess alcohol will be evaporated by heating the mixture at 95° C. for 60 minutes, with the aid of vacuum. The evaporated alcohol passes through the heat exchanger 10 to condense, and is then retrieved into alcohol tank 09. The product retained in first reactor 02 remains sitting for 90 minutes to allow a separation of the phases, glycerin and ester, to occur by gravity. The heavy phase, raw glycerin, is then removed through a bottom valve, and the light phase, fatty esters, is directed, advantageously with a continuous flow of 8 liters per hour, with the aid of air pressure pump 08, to purification column 11, where crude biodiesel percolates through a polymeric ion exchange resin, which retains substantially all of the undesired residues of glycerin, salts and catalyst. Still in continuous flow, the purified biodiesel can be stored in tank 12.

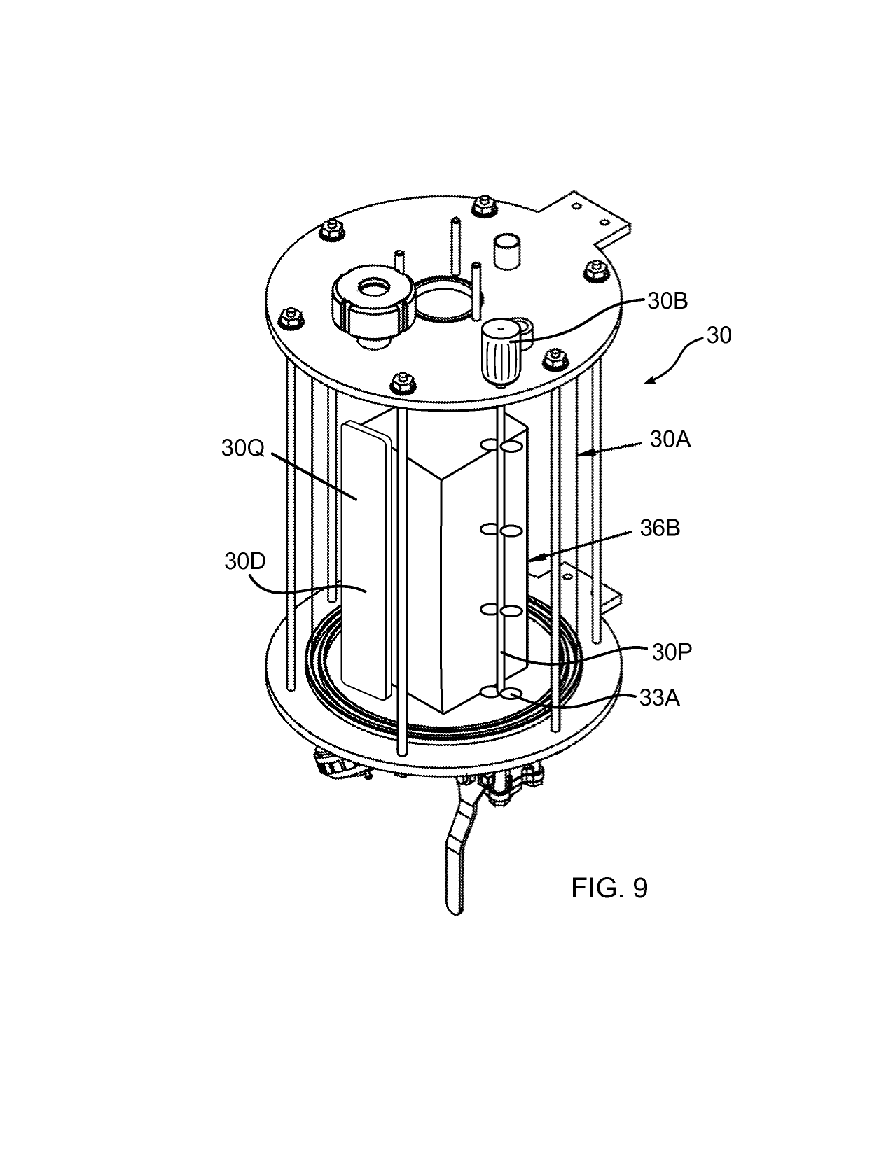

Referring now to FIG. 9, reactor 30 includes ultrasonic column 36B containing within, one or more ultrasonic transducers 30G, not visible, but as shown and described with respect to transducers 16G of FIG. 8. Also included inside bin or vessel 30A is one or more output shafts 30P bearing one or more propellers 33A, each connected to one or more stirring motors 30B, and one or more heating element assemblies 30Q, formed with heating elements 30N (not visible), which can be provided with vortex reducing and protecting covers 30D. It should be understood that the embodiment shown is exemplary, and the number, size, and relative scale of the elements described with respect to reactor 30 may be different, as best determined by the requirements and budget of a particular implementation. In one embodiment, there are at least two shafts 30P bearing propellers 33A, at least two heating elements 30Q, and at least one ultrasonic column 36B housing a plurality of transducers 30G, although the number of each may differ in accordance with the disclosure.

Reactor 30 enables the continuous production of oil, for example fresh or used vegetable cooking oil, into biodiesel, in a continuous process, without a requirement for transferring the reaction mixture to a separate vessel for treatment with ultrasound. An additional advantage is that heat can be maintained with more precision throughout the process. Further, costs are reduced as all components are housed within a single vessel 30A. Further, an overall size and weight of system 200 is reduced. Additionally, efficiency is increased, as a combination of agitation/stirring, heat, and ultrasound together produce a more efficient reaction than one or two of these treatments acting separately.

### Exemplary Computer System

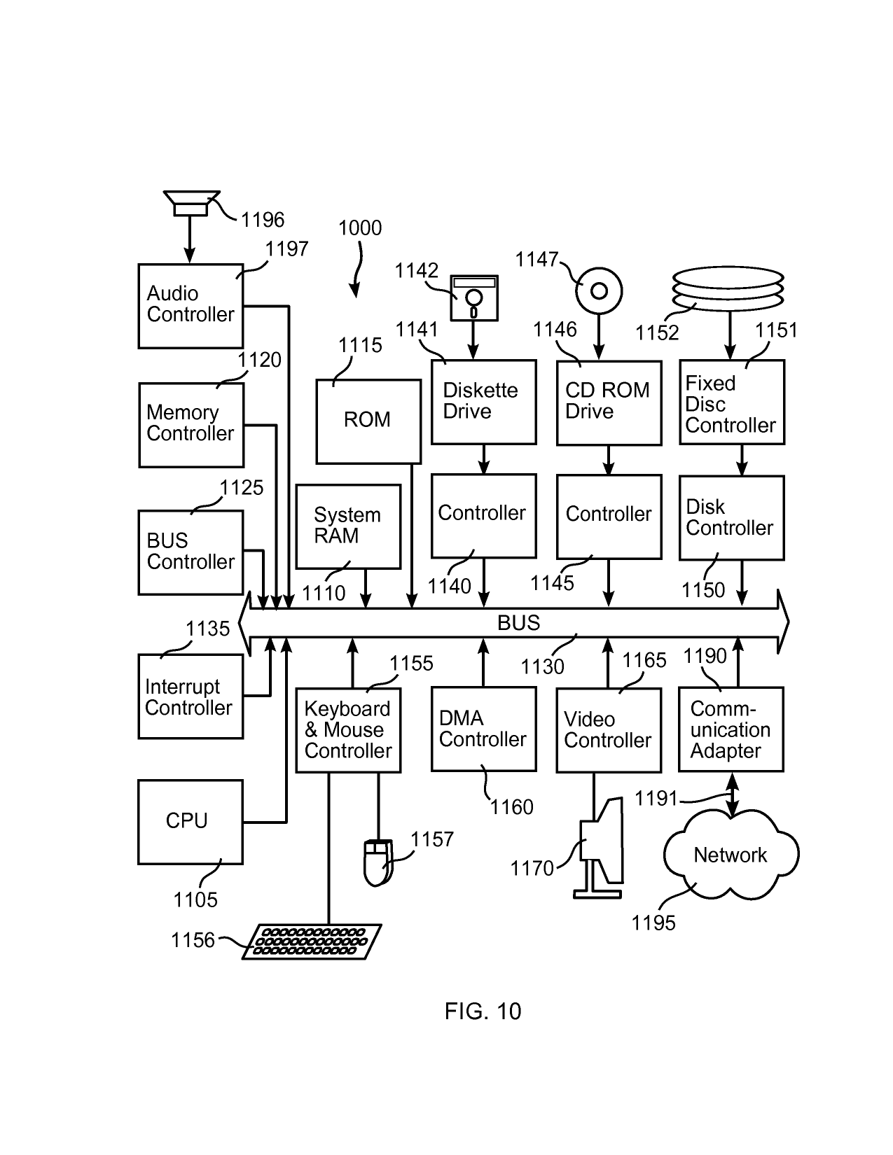

FIG. 10 illustrates the system architecture for a computer system 1000, such as a process controller, or other processor on which or with which the disclosure may be implemented. The exemplary computer system of FIG. 10 is for descriptive purposes only. Although the description may refer to terms commonly used in describing particular computer systems, the description and concepts equally apply to other systems, including systems having architectures dissimilar to FIG. 10. Computer system 1000 can control temperatures, motors, pumps, flow rates, power supplies, ultrasonic energy power generators, and valves, using actuators and transducers. One or more sensors, not shown, provide input to computer system 1000, which executes software stored on non-volatile memory, the software configured to received inputs from sensors or from human interface devices, in calculations for controlling system 200.

Computer system 1000 includes at least one central processing unit (CPU) 1105, or server, which may be implemented with a conventional microprocessor, a random access memory (RAM) 1110 for temporary storage of information, and a read only memory (ROM) 1115 for permanent storage of information. A memory controller 1120 is provided for controlling RAM 1110.

A bus 1130 interconnects the components of computer system 1000. A bus controller 1125 is provided for controlling bus 1130. An interrupt controller 1135 is used for receiving and processing various interrupt signals from the system components.

Mass storage may be provided by diskette 1142, CD or DVD ROM 1147, flash or rotating hard disk drive 1152. Data and software, including software 400 of the disclosure, may be exchanged with computer system 1000 via removable media such as diskette 1142 and CD ROM 1147. Diskette 1142 is insertable into diskette drive 1141 which is, in turn, connected to bus 1030 by a controller 1140. Similarly, CD ROM 1147 is insertable into CD

ROM drive 1146 which is, in turn, connected to bus 1130 by controller 1145. Hard disk 1152 is part of a fixed disk drive 1151 which is connected to bus 1130 by controller 1150. It should be understood that other storage, peripheral, and computer processing means may be developed in the future, which may advantageously be used with the disclosure.

User input to computer system 1000 may be provided by a number of devices. For example, a keyboard 1156 and mouse 1157 are connected to bus 1130 by controller 1155. An audio transducer 1196, which may act as both a microphone and a speaker, is connected to bus 1130 by audio controller 1197, as illustrated. It will be obvious to those reasonably skilled in the art that other input devices, such as a pen and/or tablet, Personal Digital Assistant (PDA), mobile/cellular phone and other devices, may be connected to bus 1130 and an appropriate controller and software, as required. DMA controller 1160 is provided for performing direct memory access to RAM 1110. A visual display is generated by video controller 1165 which controls video display 1170. Computer system 1000 also includes a communications adapter 1190 which allows the system to be interconnected to a local area network (LAN) or a wide area network (WAN), schematically illustrated by bus 1191 and network 1195.

Operation of computer system 1000 is generally controlled and coordinated by operating system software, such as a Windows system, commercially available from Microsoft Corp., Redmond, Wash. The operating system controls allocation of system resources and performs tasks such as processing scheduling, memory management, networking, and I/O services, among other things. In particular, an operating system resident in system memory and running on CPU 1105 coordinates the operation of the other elements of computer system 1000. The present disclosure may be implemented with any number of commercially available operating systems.

One or more applications, such as an HTML page server, or a commercially available communication application, may execute under the control of the operating system, operable to convey information to a user.

### Non-Limiting Examples

Although specific embodiments of the subject matter have been disclosed, those having ordinary skill in the art will understand that changes can be made to the specific embodiments without departing from the spirit and scope of the disclosed subject matter. The scope of the disclosure is not to be restricted, therefore, to the specific embodiments, and it is intended that the appended claims cover any and all such applications, modifications, and embodiments within the scope of the present disclosure.

1. A portable production system for biodiesel production, comprising:
a reactor including
a reaction vessel;
one or more ultrasonic transducers disposed within the reaction vessel configured to subject a biodiesel precursor to ultrasonic radiation to promote a transesterification reaction of vegetable oil and or animal fat;
a heater; and
a mechanical stirrer.

2. The system of claim 1, wherein the system is supported by a chassis having a plurality of casters, and fittings for lifting of said chassis.

3. The system of claim 1, further including:
one or more pumps for changing air pressure;
one or more pumps for liquid;
a tank for holding a recovered reactant;
a tank for holding biodiesel produced.

4. The system of claim 1, further including a dry wash purification column.

5. The system of claim 1, wherein the one or more ultrasonic transducers are piezoelectric transducers.

6. The system of claim 1, wherein the one or more ultrasonic transducers are submerged within the reaction vessel.

7. The system of claim 6, wherein the one or more ultrasonic transducers are contained within a housing.

8. The system of claim 7, wherein the housing is fabricated with titanium.

9. The system of claim 6, wherein the one or more ultrasonic transducers include a plurality of ultrasonic transducers arranged at an angle with respect to each other, to disperse ultrasonic energy throughout the reaction vessel.

10. The system of claim 1, wherein said reaction vessel is transparent.

11. The system of claim 1, wherein said heater includes one or more heater elements having a heater cover shaped to change a flow of reactants stirred by said mechanical stirrer.

12. The system of claim 1, wherein said mechanical stirrer includes an assembly having:
a motor;
an output shaft connected to the motor; and
one or more propellers connected to said output shaft.

13. The system of claim 12, wherein a plurality of said mechanical stirrer includes a plurality of said assembly.

14. The system of claim 1, wherein decantation and distillation, in addition to said ultrasonic radiation and stirring, are carried out in the reaction vessel.

15. The system of claim 1, wherein the one or more ultrasonic transducers include a plurality of ultrasonic transducers arranged within a columnar housing, each ultrasonic transducer disposed at an angle with respect to another ultrasonic transducer, said plurality of ultrasonic transducers thereby being protected by said columnar housing and disposed to disperse ultrasonic energy throughout the reaction vessel.

16. The system of claim 16, wherein said columnar housing is fabricated to promote the propagation of ultrasonic energy into the reaction vessel.

17. The system of claim 17, wherein said columnar housing is fabricated with titanium.

18. The system of claim 1, wherein the at least one ultrasonic transducer operates at one or more frequencies between about 19 kHz to 40 kHz.

19. A portable production system for biodiesel production, comprising:
a rolling chassis;
a reactor connected to said rolling chassis, and including
a reaction vessel;
one or more ultrasonic transducers disposed within the reaction vessel configured to subject a biodiesel precursor to ultrasonic radiation to promote a transesterification reaction of vegetable oil and or animal fat;
a mechanical stirrer disposed within said reaction vessel; and
a heater disposed within said reaction vessel and having at least one cover shaped to change a flow of reactants within said reactor that are stirred by said stirrer.

20. A portable production system for biodiesel production, comprising:
a chassis;
a reactor connected to said rolling chassis, and including
a reaction vessel;
one or more ultrasonic transducers configured to transmit ultrasonic radiation into an interior of the reaction vessel;
a mechanical stirrer disposed within said reaction vessel; and
a heater disposed within said reaction vessel and having at least one cover shaped to change a flow of reactants within said reactor that are stirred by said stirrer.
